(19) United States
(12) Patent Application Publication
(10) Pub. No.: US 2006/0002475 A1
(43) Pub. Date: Jan. 5, 2006

(54) Caching data for video edge filtering

(76) Inventor: Robert J. Fuchs, San Diego, CA (US)

Correspondence Address: QUALCOMM, INC, 5775 MOREHOUSE DR., SAN DIEGO, CA, 92121, US

(21) Appl. No.: 11/022,533

(22) Filed: Dec. 22, 2004

Related U.S. Application Data
(60) Provisional application No. 60/585,498, filed on Jul. 2, 2004.

(51) Int. Cl. H04B 1/66; H04N 11/02; H04N 11/04; H04N 7/12

(52) U.S. Cl. 375/240.24; 375/240.29

(57) ABSTRACT

An embodiment of the present invention pertains to an apparatus and method for caching pixel data used in filtering edges of video macroblocks. Pixel data which are required to edge filter subsequent macroblocks are temporarily stored in a cache memory. When a macroblock is subsequently being processed, this cached pixel data is read out and used to filter the corresponding edge(s). By caching select pixel values rather than writing them to external memory, the number of memory accesses is dramatically reduced.

The present application for patent claims priority to Provisional Application No. 60/585,498 entitled “Method and Apparatus for Video Filtering” filed Jul. 2, 2004, and assigned to the assignee hereof and hereby expressly incorporated by reference herein.

### FIELD

The present invention relates to a method and apparatus for caching pixel data used in filtering edges of video macroblocks.

### BACKGROUND

Digital video is proliferating with the introduction and wide-spread popularity of digital camcorders, digital cameras, video-CD, DVD, digital television, digital audio broadcasting, computer-generated video, etc. Indeed, cellular telephones today have the ability to record and wirelessly transmit video images. One major obstacle encountered with digital video applications relates to the inordinate amount of digital data representing a typical video file. The sheer volume of digital data associated with video files, makes processing, transmitting, and storing these video files a complex and costly task.

In order to reduce costs and simplify the amount of effort associated with video processing, transmissions, and storage, many different video compression/de-compression techniques have been developed and established. Some of the better known and more widely adopted video compression/de-compression standards include MPEG4, H264, Windows Media™, and RealVideo™. In a typical compression scheme, an input video stream is analyzed and information is selectively discarded to “compress” the video file, thereby reducing its overall size. And because the compressed video file is much smaller than the original video file, it becomes easier, faster, and less expensive to work with the compressed video file. Subsequently, the compressed video file is de-compressed for playback. Although, upon playback, the quality of the de-compressed video images is not as good as compared to the original video images, this slight degradation is more than offset by the advantages conferred by applying video compression/de-compression techniques. Consequently, digital video applications almost invariably include some form of video compression/de-compression.

For purposes of video compression/de-compression, a video stream is processed one frame at a time. Typically, a video frame is divided into a number of more manageable macroblocks. Each macroblock contains a fixed array of pixels (e.g., a 16×16 pixel array). In many instances, a macroblock is further sub-divided into smaller blocks of pixels (e.g., a 4×4 pixel array). By dividing the frame into a multitude of blocks, the various stages of a compression/decompression chip can process several blocks simultaneously in a pipelined architecture. This pipelined processing increases the speed by which the video can be compressed and decompressed, which is of great import for supporting high resolution and high rate video streams.

Unfortunately, one side-effect of compressing/de-compressing on a macroblock basis is that the edges of the macroblocks may exhibit unwanted artifacts or other types of distortions. When the macroblocks comprising a video frame are assembled for display, these artifacts and distortions may render the video to appear choppy, jagged, or skewed in places. The resulting video image is visually unsettling and quite unappealing.

One common solution to overcoming this problem entails filtering the edges of the macroblocks. In filtering, a number of pixels residing on both sides of an edge have their respective values adjusted or “balanced” according to a filtering algorithm. The adjusted or “filtered” pixel values result in smoothening of the edges. The end result is a much more visually gratifying video image.

However, the downside to filtering edges is that it necessitates a multitude of memory accesses. Due to the high volume of digital data being handled, once a block has initially been processed, the encoder/decoder chip responsible for compressing and de-compressing the video stream, typically writes that data out to an external memory for storage. But, because filtering requires pixel data from both sides of an edge, the encoder/decoder chip must obtain pixel data not only corresponding to the current block, but also from an adjacent block, for it to accomplish its filtering. Consequently, the encoder/decoder chip must execute a memory access to read pixel data stored in external memory corresponding to a previously processed adjacent block. After the pixel values have been adjusted, the newly filtered pixel values corresponding to the current block are written to the external memory. This necessitates another memory access request. Furthermore, the pixels corresponding to the adjacent block have also had their values changed by the filtering process. This means that the filtered pixel values corresponding to the adjacent block must now also be written back to the memory. Hence, yet another memory access request is executed. This read/write memory access routine is repeated for each and every block. The net result is the same pixels have to be re-read from external memory a multitude of times. Over the course of compressing/de-compressing a video stream, the number of associated read/write memory access requests can detrimentally impact the performance of the system.

Executing memory access requests is costly in terms of time, decreased system efficiency, and power. It takes time to issue the memory requests. And because the bus is shared amongst a number of system components, if another component is currently utilizing the bus, the transaction corresponding to that component must complete its execution before the bus becomes available. It also takes time to actually retrieve the data from memory or write data into the memory. In addition, if the bus is servicing memory access requests issued by the compression/decompression chip, other components and chips in the system are locked out from using the bus in that time interval. All of these factors tend to degrade the overall system performance. Furthermore, for each memory access, a small amount of power is consumed. Excessive memory accesses can cause the battery of portable video devices to drain much faster than desired.

Therefore, it would be highly desirable if there were some way by which memory accesses can be minimized, while at the same time supporting edge filtering so that video compression/de-compression can be effectively applied.

### SUMMARY

Apparatus and methods are presented for storing pixel data used in filtering edges of video macroblocks in a cache memory rather than an external memory. Pixel data which are required to edge filter subsequent macroblocks are temporarily stored in a cache memory. When a macroblock is subsequently being processed, this cached pixel data is read out and used to filter the corresponding edges. By selectively caching certain pixels, rather than automatically writing them all out to external memory, the number of memory accesses is substantially reduced to a single memory write transaction per pixel.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a block diagram of an exemplary video system upon which the present invention may be practiced.

FIG. 2 is a flowchart describing a cached filter pixel data process in accordance with one embodiment of the present invention.

FIG. 3 shows a video frame which is divided into a 16×16 array of macroblocks.

FIG. 4 shows the sixteen video blocks which comprise a macroblock.

FIG. 5 shows how pixel data is to be cached for a first macroblock.

FIG. 6 shows how pixel data is cached for a second macroblock.

FIG. 7 shows how pixel data is cached for a third macroblock.

FIG. 8 shows how pixel data is cached for a macroblock in a second scan line.

FIG. 9 shows one particular application of one embodiment of the present invention is now described in great detail.

FIG. 10 shows the nine cases of how writes occur to external memory, for filtered macroblocks. Each 16×16 block in bold lines represents a macroblock, and each shaded region depicts the actual pixels that get written out for that macroblock once filtering is done.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

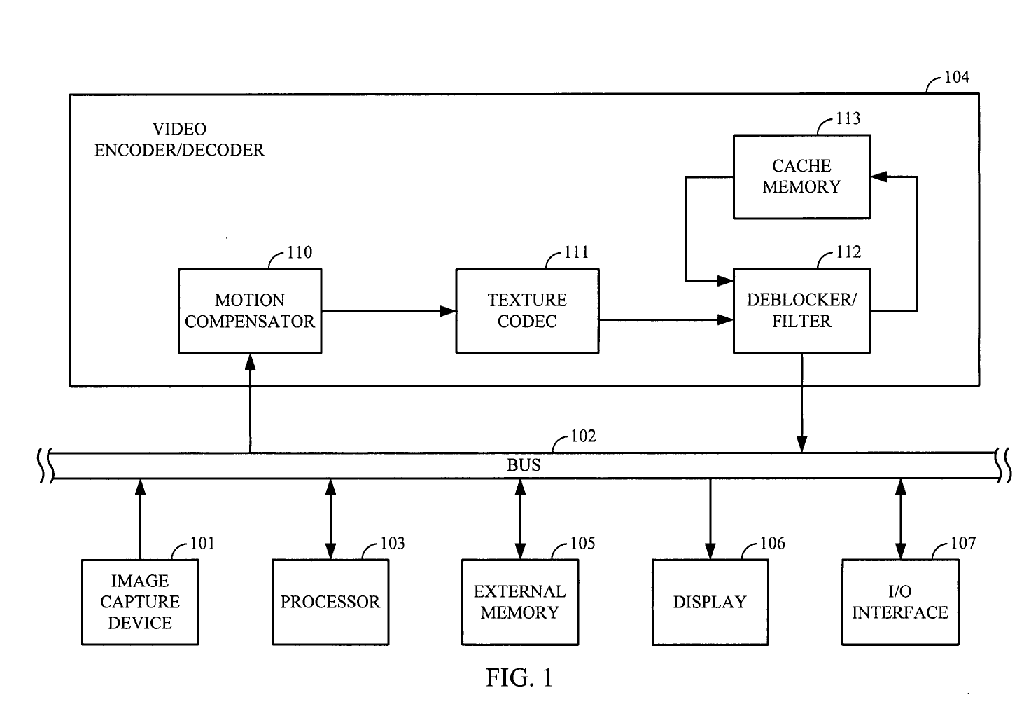

A method and system for caching pixel data for edge filtering of video macroblocks is disclosed. FIG. 1 shows a block diagram of an exemplary video system upon which the present invention may be practiced. Images are captured from an image capture device 101 (e.g., a charge-coupled device—CCD). The electrical signals from the image capture device are processed into a video stream by processor 103 (e.g., a digital signal processor—DSP, state machine, etc.) and sent via bus 102 to encoder/decoder 104. Video encoder/decoder 104 compresses the incoming video stream and sends the compressed video data over bus 102 for storage in an external memory 105. Video encoder/decoder 104 also reads video data from external memory 105, de-compresses the video data, and then sends the de-compressed video data for rendering on a display 106. An input/output (I/O) interface 107 is used to accept human input as well as to provide an interface for external devices.

In one embodiment, video encoder/decoder 104 includes a motion compensator 110, a texture codec 111, and a deblocker/filter 112. Motion compensator 110 predicts the values of pixels by relocating a block of pixels from the last picture. This motion is described by a two-dimensional vector or movement from its last position. The texture codec 111 performs texture coding and decoding. Deblocker/filter 112 takes compressed video data and burst writes it over bus 102 for storage in external memory 105. Deblocker/filter 112 is also responsible for filtering the edges of video blocks before the video is written out to external memory.

A cache memory 113 is coupled to deblocker/filter 112. Pixel data which will be used in future filtering operations is temporarily stored in cache memory 113. When it comes time to subsequently filter these video blocks, the pixel data corresponding to adjacent edges are already retained in cache memory 113. Consequently, the deblocker/filter 112 reads the requisite pixel data from cache memory 113. In the prior art, the pixel data of adjacent edges would have to be read from external memory 105, which would require a memory access request to read this data. By implementing an internal cache memory, embodiments of the present invention eliminate the need to perform a memory access to read data from external memory 105 for purposes of edge filtering. In one embodiment, cache memory 113 is an internal section of static random access memory (SRAM). The SRAM memory is fabricated as part of the encoder/decoder chip 103. By fabricating cache memory directly into and as part of the encoder/decoder chip 103, pixel data can be written into this internal cache memory and read from this cache memory directly without having to go outside of the chip, over an external bus, and to an external memory chip. Due to cache memory 103, each pixel needs to be written out of deblocker to external memory 105 only once, and no pixels need to be read in from external memory 105.

By minimizing the number of memory access requests, the embodiments accomplish edge filtering much faster and more efficiently than conventional systems. Furthermore, the implementation of any of the embodiments reduces power consumption. It should be noted that the exemplary system of FIG. 1 describes various components associated with a video system in the context as an aid in describing embodiments. However, other components can be included, omitted, or substituted thereupon without departing from the scope of the present invention. Moreover, the pixel cache edge filtering apparatus and method of the present invention can be readily adapted to virtually any video encoder/decoder apparatus, system, or subsystem.

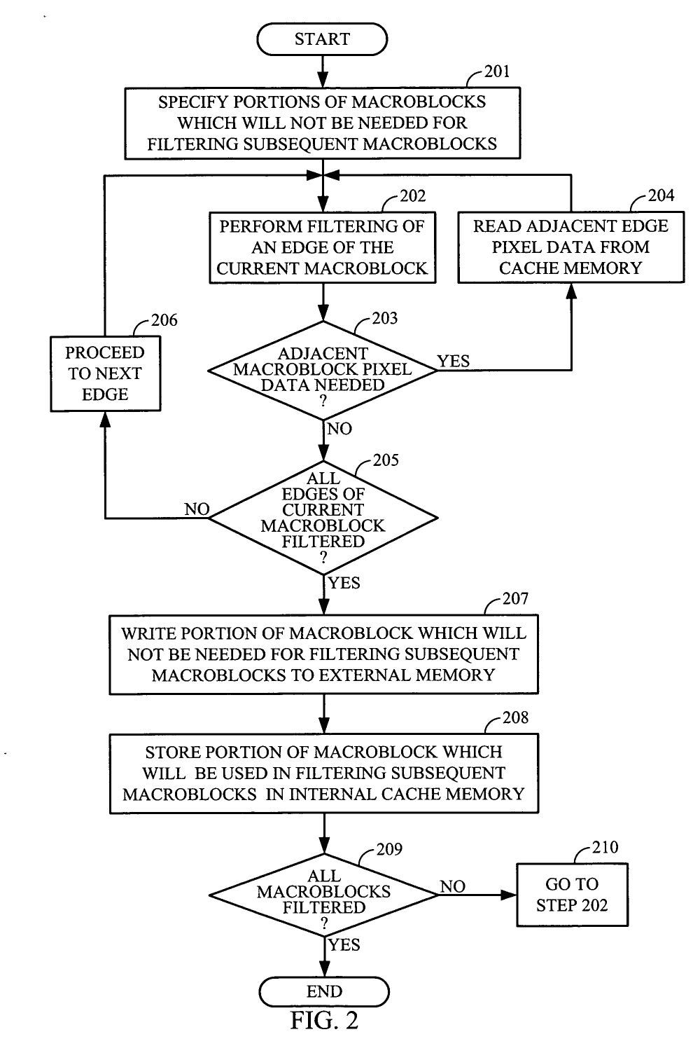

FIG. 2 is a flowchart describing the steps for the cached filter pixel data process. Initially, at 201, embodiments of the process specify the portions of each macroblock which will not be needed for the filtering of subsequent macroblocks. These portions may be different, depending on the respective location of each macroblock in the video frame. The video frame is raster scanned one macroblock at a time. For each of the macroblocks, the edges of that macroblock are filtered, as will be described in detail below with respect to 202-206. Specifically, in 202, the filtering process is performed on one edge of the current macroblock. As part of the filtering process, a determination is made as to whether pixel data belonging to an adjacent macroblock is needed in order to filter the current edge in 203. If pixel data belonging to an adjacent macroblock is needed for filtering the current edge, the pixel data is read from the cache memory in 204. Hence, reading from cache memory eliminates the need for issuing a memory access to the external memory. Once this pixel data is retrieved from the cache memory, the actual filtering can then be accomplished on the current edge in 202. Otherwise, if pixel data from an adjacent macroblock is not needed, the current edge is simply filtered in 202. Each edge of the macroblock is thusly filtered until all edges corresponding to the current macroblock has successfully been filtered (see 205-206).

Once all edges of the current macroblock have been filtered, the portion of the macroblock which will not be needed for filtering subsequent macroblocks (as specified in 201) is written to external memory in 207. Because this portion will not be needed for filtering subsequent macroblocks, it will not be modified as part of any subsequent edge filtering. Consequently, this portion is written once and only once to the external memory. By writing portions of macroblocks once and only once to external memory, the need to perform read-modify-write memory accesses is eliminated. The other portion of the macroblock, the portion that will be used in filtering subsequent macroblocks, is stored in the cache memory. This is represented by 208. In 209 and 210, it is ensured that the above 202-208 processes of edge filtering a macroblock are repeated for each and every macroblock in the video frame. Thus, 201-210 lay out the process of how caching is applied to edge filter video macroblocks.

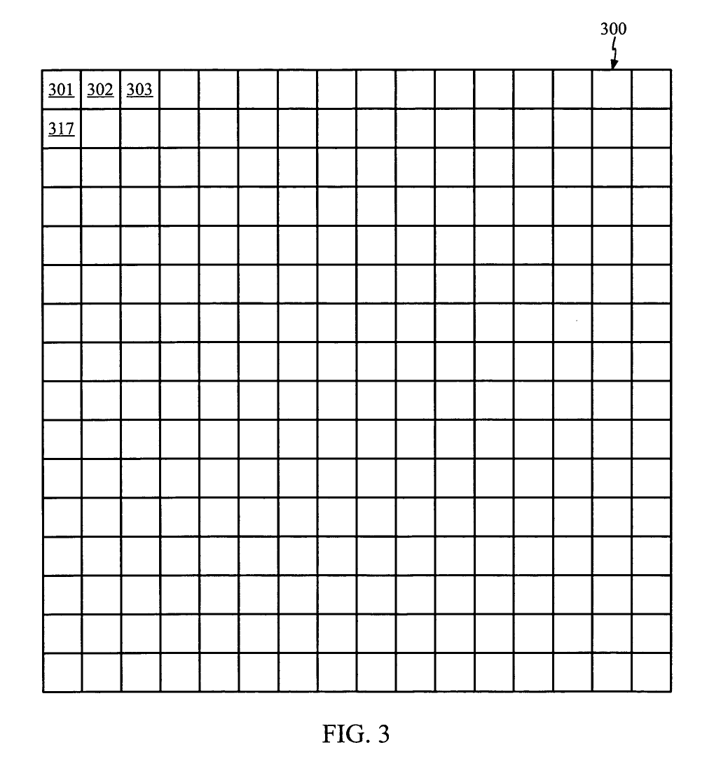

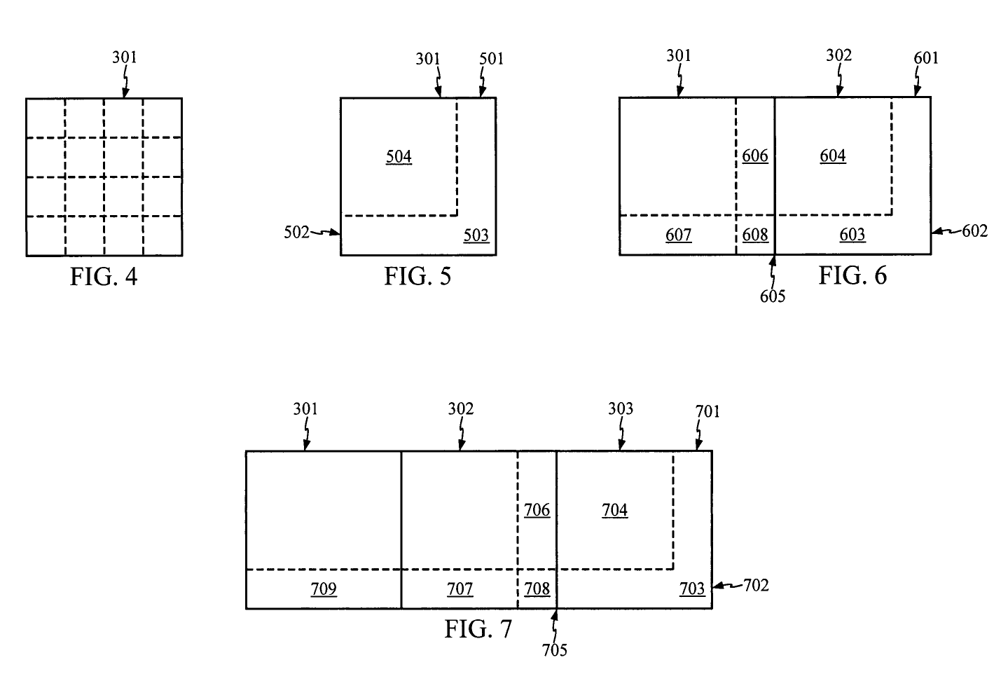

FIGS. 3 and 4 depict how edges of a video frame are identified for filtering. In FIG. 3, a video frame 300 is divided into a number of macroblocks which are depicted as 301, 302, 303, . . . 317, . . . etc. In one embodiment, the video frame 300 is divided into an array of 16×16 macroblocks, for a total of 256 macroblocks. The macroblocks are raster scanned from left to right and from top to bottom. Each of the macroblocks are further subdivided into video blocks. In one embodiment, each macroblock is sub-divided into 4×4 arrays of video blocks. FIG. 4 shows a 4×4 array of video blocks which comprise macroblock 301. As a result of this sub-division, each macroblock has four columns and four rows of video blocks for a total of sixteen video blocks. The four left edges of each of the four columns (i.e., sixteen edges) and the four top edges of each of four rows (i.e., sixteen edges) of video blocks are edge filtered. Thus, there are thirty-two edges which need to be filtered per macroblock.

After edge filtering is applied to these thirty-two edges of a video block, a pre-determined portion of the pixel data is written out, over the bus, to be stored in the external memory. The remaining portion of pixel data is stored in the internal cache. The portion of pixel data written out to external memory are those pixel data which will not be needed for performing edge filtering corresponding to subsequent macroblocks. Thereby, in one embodiment, filtered pixel data is written out to external memory once and only once. In comparison, the embodiments are directed towards performing write operations to external memory, as opposed to prior art systems which perform read-modify-write operations to external memory.

The pixel data which will be needed for edge filtering of subsequent macroblocks are stored in the internal cache memory. In the course of performing edge filtering, when pixel data corresponding to an adjacent macroblock is needed, this pixel data is read from the internal cache memory. Thus, in one embodiment, pixel data is never read back from external memory for purposes of edge filtering. The combination of writing specific filtered pixel data out to external memory only one time and never reading pixel data out from external memory, significantly reduces the number of external memory accesses required for edge filtering. As explained above, keeping the number of memory accesses to a minimum is highly advantageous.

Referring now to FIGS. 5-7, the following description of some of the embodiments describes in detail the way in which a particular portion of macroblock pixel data is determined to be written out to external memory and which portion is to be stored in the internal cache. The first macroblock to be raster scanned in any video frame corresponds to the one in the top-leftmost corner. FIG. 5 shows how pixel data is to be cached for a first macroblock. The first macroblock to be processed is shown as macroblock 301. There is a macroblock to the right of macroblock 301 which will subsequently have to be edge filtered. As a result, a vertical stripe 501 of pixel data along the right edge of macroblock 301 is stored in the internal cache memory. The width of the pixel column 501 varies, depending on the particular coding standard being supported. Likewise, there is a macroblock below macroblock 301. The macroblock residing directly underneath macroblock 301 will have to be subsequently edge filtered. Thus, a horizontal stripe 502 along the bottom edge of macroblock 301 must be stored in the internal cache. Again, the pixel height of the horizontal stripe 502 depends on the particular coding standard being supported. Thereby, the combination of the vertical stripe and horizontal stripe, depicted as portion 503, is stored in the internal cache memory. The remaining portion, depicted as portion 504, of pixel data is not needed for edge filtering. Hence, portion 504 is written out to the external memory for storage. And because portion 504 is not needed for edge filtering of future macroblocks, the pixel data is written out to external memory once and only once for purposes of edge filtering. This aspect of the embodiments saves the video system from having to perform a read-modify-write operation on this data, which cuts down on the number of memory accesses required.

FIG. 6 shows how pixel data is cached for a second macroblock. Macroblock 302 is raster scanned next, following macroblock 301. There is a macroblock to the right of macroblock 302 which will subsequently have to be edge filtered. As a result, a vertical stripe 601 of pixel data along the right edge of macroblock 302 is stored in the internal cache memory. Likewise, there is a macroblock below macroblock 302 which will have to be subsequently edge filtered. Thus, a horizontal stripe 602 along the bottom edge of macroblock 302 must be stored in the internal cache. Thereby, the combination of the vertical stripe and horizontal stripe, depicted as portion 603, is stored in the internal cache memory. The remaining portion, depicted as portion 604, of pixel data is not need for edge filtering. Hence, portion 604 is written out to the external memory for storage.

In addition, in processing macroblock 302, edge 605 is edge filtered. The vertical stripe of pixel data to the right of edge 605 is available as part of the current macroblock 302. The vertical stripe of pixel data to the left of edge 605 was previously stored in internal cache memory when processing macroblock 301. Hence, the vertical stripe of pixel data to the left of edge 605 is now read from the internal cache memory and used to filter edge 605. In filtering edge 605, the pixel data corresponding to the vertical stripe is modified. The upper portion 606 of this vertical stripe of pixel data can now be written out to external memory because it is no longer needed for edge filtering of subsequent macroblocks. Once upper portion 606 is written out to external memory, there is no need to keep this pixel data in the internal cache memory. The bottom portion 608 of the vertical stripe has had its pixel data modified as part of filtering edge 605. Consequently, the modified pixel data of portion 608 can now be updated accordingly in the internal cache memory. Note, however, that the bottom portion 607 of macroblock 301 must still be maintained in the internal cache memory because the macroblock residing directly below macroblock 301 has yet to be processed and edge filtered. Therefore, in edge filtering macroblock 302, pixel data portions 604 and 606 are written once and only once to external memory; modified pixel data belonging to portion 608 must be updated in internal cache memory; pixel data portion 607 is maintained in the internal cache memory; and pixel data portion 603 is stored in the internal cache memory.

FIG. 7 shows how pixel data is cached for a third macroblock. Macroblock 303 is raster scanned next, following macroblock 302. There is a macroblock to the right of macroblock 303 which will subsequently have to be edge filtered. As a result, a vertical stripe 701 of pixel data along the right edge of macroblock 303 is stored in the internal cache memory. Likewise, there is a macroblock below macroblock 303 which will have to be subsequently edge filtered. Thus, a horizontal stripe 702 along the bottom edge of macroblock 303 must be stored in the internal cache memory. Thereby, the combination of the vertical stripe and horizontal stripe, depicted as portion 703, is stored in the internal cache memory. The remaining portion, depicted as portion 704, of pixel data is not need for edge filtering. Hence, portion 704 is written out to the external memory for storage.

In addition, in processing macroblock 303, edge 705 is edge filtered. The vertical stripe of pixel data to the right of edge 705 is available as part of the current macroblock 303. The vertical stripe of pixel data to the left of edge 705 was previously stored in internal cache memory when processing macroblock 302. Hence, the vertical stripe of pixel data to the left of edge 705 is now read from the internal cache memory and used to filter edge 705. In filtering edge 705, the pixel data corresponding to the vertical stripe to the immediate left of edge 705 becomes modified. The upper portion 706 of this vertical stripe of pixel data can now be written out to external memory because it is no longer needed for edge filtering of subsequent macroblocks. Once upper portion 706 is written out to external memory, there is no need to keep this pixel data in the internal cache memory. The bottom portion 708 of the vertical stripe has had its pixel data modified as part of filtering edge 705. Consequently, the modified pixel data of portion 708 must be updated accordingly in the internal cache memory.

Note, however, that the bottom portion 707 of the horizontal stripe of pixel data belonging to macroblock 302 must still be maintained in the internal cache memory because the macroblock residing directly below macroblock 302 has yet to be processed and edge filtered. Furthermore, the horizontal stripe 709 of pixel data belonging to macroblock 301 must also be maintained in the internal cache memory. The horizontal stripe 709 of pixel data must stay in the internal memory until the macroblock residing directly underneath macroblock 301 has been processed and edge filtered. Therefore, in edge filtering macroblock 303, pixel data portions 704 and 706 are written once and only once to external memory; modified pixel data belonging to portion 708 must be updated in internal cache memory; pixel data for portions 707 and 709 are maintained in the internal cache memory; and pixel data portion 703 is stored in the internal cache memory.

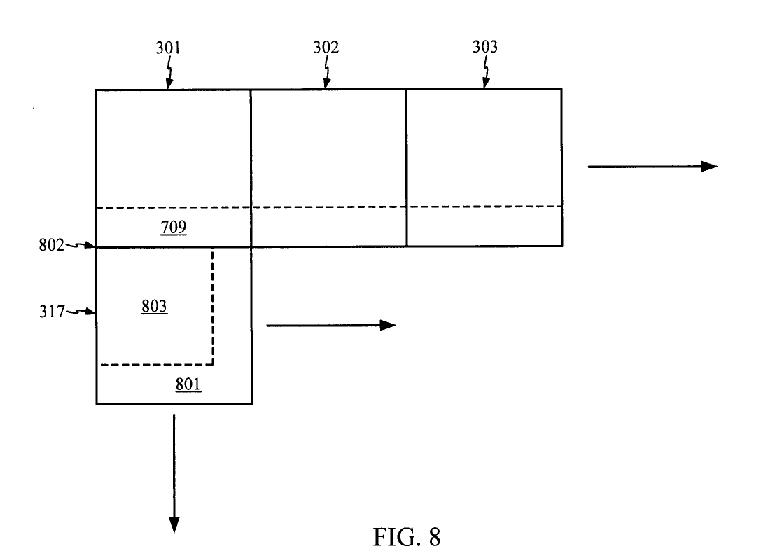

The process described above is repeated for the first line of raster scanned macroblocks. In processing a second scan line, a similar caching approach is utilized. FIG. 8 shows how pixel data is cached for a macroblock in a second scan line. Macroblock 317 resides directly underneath macroblock 301. In processing macroblock 317, the pixel data for portion 801 is stored in the internal cache memory in order to support edge filtering of the macroblocks immediately to the right of and below macroblock 317. When filtering edge 802, the pixel data of horizontal stripe 709 is read from the internal cache memory. This pixel data of horizontal stripe 709 and the pixel data corresponding to a horizontal stripe along edge 802 of macroblock 803 are modified according to a filtering algorithm. After edge 802 is filtered, the modified pixel data of horizontal stripe 709 is written out to the external memory and can be deleted from the internal cache memory. The pixel data belonging to portion 803 is also written out to external memory for storage. And the pixel data corresponding to the other macroblocks of the first scan line are still maintained in the internal cache memory., along with portion 801.

The caching process described above for edge filtering macroblocks is repeated until the entire video frame has been raster scanned.

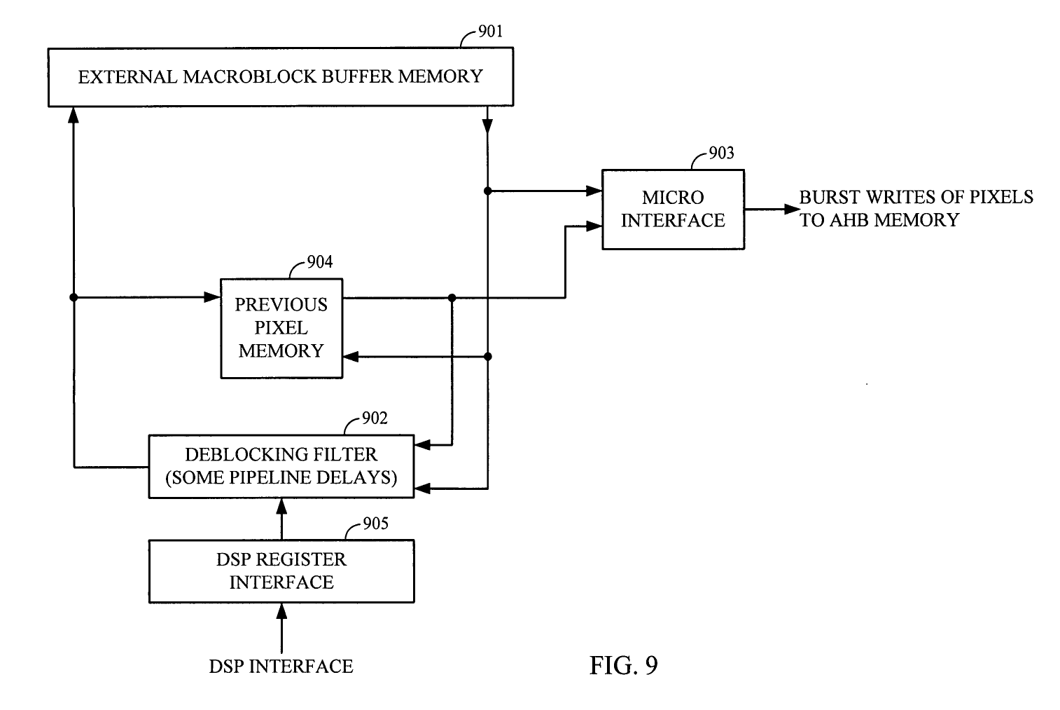

FIG. 9 shows one particular application of one embodiment of the present invention. In this embodiment, a H264 encoding standard is utilized. In this embodiment, the deblocker hardware is configured to read pixels from macroblock buffer memory 901, in the order Y, Cr, Cb, to apply the deblocking filter 902 to the macroblock. The resulting pixels are then burst written out over an Advanced High Performance (AHB) bus to memory via micro interface 903. In one embodiment, the deblocking filter 902 has 1448×32 previous line buffer or cache to store four vertical pixels and four horizontal pixels to the left of and to the top of the current macroblock. The pixels stored in the previous pixel memory 904, are used by the filter to perform the filtering. The deblocking filter 902 may be used in conjunction with Y, Cr, and/or Cb pixel types. Y, Cr and Cb pixel types are also known as luminance and chrominance signals. Note that other pixel types, such as RGB, may be the information that is stored and manipulated in the manner described by the embodiments. A DSP register interface 905 provides an interface between the DSP and the deblocking filter 902.

When filtering a macroblock, previous line storage (e.g., previous pixel memory 904) is required because when one filters the current macroblock, the filtering could affect up to three pixels to the left and to the top of the current macroblock. To eliminate the need for read-modify-write operations when writing out macroblocks, and to make all writes fit neatly into words, the deblocking filter hardware stores four pixels to the left of every macroblock. Also, this allows for easier future filters which may require up to four pixels on each side of the edge. Horizontally, pixels need to be stored all the way across the frame. Vertically, only the previous macroblock's pixels need to be stored. Also, the memory (e.g., previous pixel memory 904 and AHB memory) that holds these pixels needs to be double buffered to permit two different frames to be able to be deblocked with their macroblocks interleaved. This is to support interleaved macroblock decode and encode.

In this embodiment, the largest frame supported for deblocking is CIF, which is twenty-two macroblocks wide. The memory used to store these pixels is 32 bits wide (4 pixels wide) to facilitate fast reads and writes during deblocking. Horizontally, the total number of pixels that need to be stored for Y is:

22*(16*4)=1408 pixels=352 words

Horizontally, the total number of pixels that need to be stored for Cr or Cb is:

22*(8*4)=704 pixels=176 words

Vertically, the total number of pixels that need to be stored for Y is:

4*12=48 pixels=12 words

Vertically, the total number of pixels that need to be stored for Cr or Cb is:

4*4=16 pixels=4 words

So the total number of pixels stored is:

2*{1408+2*704+48+2*16}=2896 pixels=724 words.

Table 1 below shows a previous line buffer for storing pixel values.

TABLE 1
Previous Line Buffer Pixel Storage
previous buffer consists of a 1448 × 32 memory

| | | | | | | |
|---|---|---|---|---|---|---|
| BANK 1 | | 1447 | | | | |
| | | 724 | | | | |
| BANK 0 | Cb VERT | 723 | Cb₁₅ | Cb₁₄ | Cb₁₃ | Cb₁₂ |
| | | 720 | Cb₃ | Cb₂ | Cb₁ | Cb₀ |
| | Cr VERT | 719 | Cr₁₅ | Cr₁₄ | Cr₁₃ | Cr₁₂ |
| | | 716 | Cr₃ | Cr₂ | Cr₁ | Cr₀ |
| | Y VERT | 715 | Y₄₇ | Y₄₆ | Y₄₅ | Y₄₄ |
| | | 704 | Y₃ | Y₂ | Y₁ | Y₀ |
| | MB_POS_H = 21 | 703 | Cb₃₁ | Cb₃₀ | Cb₂₉ | Cb₂₈ |
| | | 696 | Cb₃ | Cb₂ | Cb₁ | Cb₀ |
| | Cb HOR | | | | | |
| | MB_POS_H = 0 | 535 | Cb₃₁ | Cb₃₀ | Cb₂₉ | Cb₂₈ |
| | | 528 | Cb₃ | Cb₂ | Cb₁ | Cb₀ |
| | MB_POS_H = 21 | 527 | Cr₃₁ | Cr₃₀ | Cr₂₉ | Cr₂₈ |
| | | 520 | Cr₃ | Cr₂ | Cr₁ | Cr₀ |
| | Cr HOR | | | | | |
| | MB_POS_H = 0 | 359 | Cr₃₁ | Cr₃₀ | Cr₂₉ | Cr₂₈ |
| | | 352 | Cr₃ | Cr₂ | Cr₁ | Cr₀ |
| | MB_POS_H = 21 | 351 | Y₆₃ | Y₆₂ | Y₆₁ | Y₆₀ |
| | | | Y₃ | Y₂ | Y₁ | Y₀ |
| | Y HOR | | | | | |
| | MB_POS_H = 0 | 15 | Y₆₃ | Y₆₂ | Y₆₁ | Y₆₀ |
| | | 0 | Y₃ | Y₂ | Y₁ | Y₀ |
| | | | 32 | | | |

In this embodiment, macroblocks are written to the bus through the deblocker. In external memory, macroblocks are stored horizontal line by horizontal line, in raster scan order, 4 pixels per word. The Y frame is stored at one address location and Cr/Cb are interleaved in each word, and stored at another address location. If the macroblock is not filtered, then the writing of the macroblock to external memory is the same, regardless of the position of the macroblock. If the macroblock is filtered, then a variable-sized block of pixels is written to external memory because the right most and bottom most lines of the macroblock need to be stored in the previous pixel buffer. Pixels are filtered up to four times over by the deblocking filter so pixels can only be written out to memory when they are completely filtered.

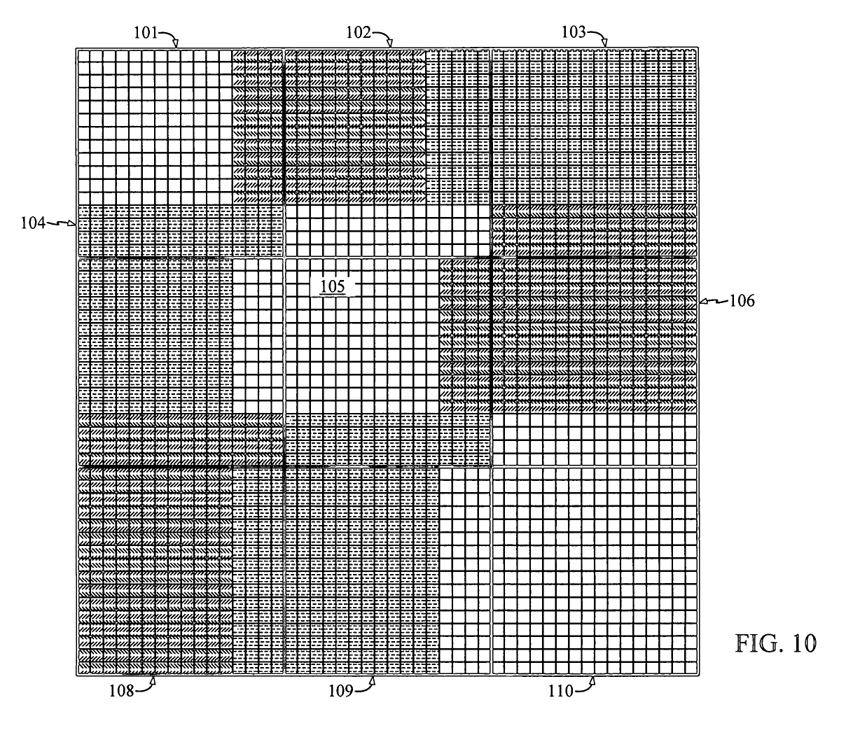

FIG. 10 shows the nine cases of how writes occur to external memory, for filtered macroblocks. These nine cases are based on the position of the macroblock in the frame. The nine different portions 1001-1009 indicate the pixels that are completely filtered and can be written out to external memory when filtering on the corresponding macroblock is complete.

Table 2 below shows a chart describing the deblocker pixel writing conditions.

TABLE 2
Deblocker Pixel Writing Conditions

| Case | condition | Y | Cr/Cb |
|---|---|---|---|
| Top left | MB_POS_H = 0 | 12 bursts | 4 bursts of 2 |
| corner | MB_POS_V = 0 | of 3 words | words |
| top | 0 < MB_POS_H < | 12 bursts | 4 bursts of 4 |
| edge | MB_MAX_H − 1 | of 4 words | words |
| | MB_POS_V = 0 | | |
| top | MB_POS_H = MB_MAX_H − 1 | 12 bursts | 4 bursts of 6 |
| right | MB_POS_V = 0 | of 5 words | words |
| corner | | | |
| left | MB_POS_H = 0 | 4 bursts of | 4 bursts of 4 |
| edge | 0 < MB_POS_V < | 4 words | words |
| | MB_MAX_V − 1 | 12 bursts | 4 bursts of 2 |
| | | of 3 words | words |
| In the | 0 < MB_POS_H < | 4 bursts of | 4 bursts of 4 |
| middle | MB_MAX_H − 1 | 4 words | words |
| | 0 < MB_POS_V < | 12 bursts | 4 bursts of 4 |
| | MB_MAX_V − 1 | of 4 words | words |
| right | MB_POS_H = MB_MAX_H − 1 | 4 bursts of | 4 bursts of 4 |
| edge | 0 < MB_POS_V < | 4 words | words |
| | MB_MAX_V − 1 | 12 bursts | 4 bursts of 6 |
| | | of 5 words | words |
| Bottom | MB_POS_H = 0 | 4 bursts of | 4 bursts of 4 |
| left | MB_POS_V = MB_MAX_V − 1 | 4 words | words |
| corner | | 16 bursts | 8 bursts of 2 |
| | | of 3 words | words |
| Bottom | 0 < MB_POS_H < | 4 bursts of | 4 bursts of 4 |
| edge | MB_MAX_H − 1 | 4 words | words |
| | MB_POS_V = MB_MAX_V − 1 | 16 bursts | 8 bursts of 4 |
| | | of 4 words | words |
| Bottom | MB_POS_H = MB_MAX_H − 1 | 4 bursts of | 4 bursts of 4 |
| right | MB_POS_V = MB_MAX_V − 1 | 4 words | words |
| corner | | 16 bursts | 8 bursts of 6 |
| | | of 5 words | words |

It can be seen that the longest group of bursts is the bottom right corner: (4*4)+(16*5)+(4*4)+(8*6)=160 writes. It should be noted that this does not take into account the bus arbitration delays. The deblocker is not the sole master of the bus.

After filtering is completed, pixels are copied from the macroblock buffer to the previous line buffer. The pixels are written out to external memory from a combination of the previous line buffer memory and the macroblock buffer memory. After this writing is complete, pixels then need to be copied from the right most 4×4 blocks and bottom most 4×4 blocks from the macroblock buffer to the previous line buffer memory. The bottom most 16×4 block of pixels of Y, and 8×4 block of pixels for Cr/Cb, is copied from the macroblock buffer to the previous line buffer. This is copied into the appropriate location depending on the value of MB_POS_H (0 through 21). This is copied on every macroblock except when MB_POS_V=MB_MAX_V−1 (bottom most macroblocks). The right and top most 4×12 block of pixels of Y, and the 4×4 block of pixels for Cr/Cb, is copied from the macroblock buffer to the previous line buffer. This is copied in the same location for every macroblock. In addition, this is copied on every macroblock except when MB_POS_H=MB_MAX_H−1 (right most macroblocks).

In conclusion a method and apparatus for caching pixel data used in filtering edges of video macroblocks has been disclosed. The foregoing descriptions of specific embodiments have been presented for purposes of illustration and description. They are not intended to be exhaustive or to limit the invention to the precise forms disclosed, and many modifications and variations are possible in light of the above teaching. Furthermore, although embodiments of the present invention have been described in reference to video, it should be appreciated that the present invention is not limited to video. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for processing an edge between a first macroblock of pixel data and a second macroblock of pixel data, comprising:
storing a first set of pixel data corresponding to said first macroblock in a cache memory;
reading said first set of pixel data from said cache memory;
filtering said first set of pixel data and a second set of pixel data corresponding to said second macroblock to generate filtered pixel data;
writing a first portion of said filtered pixel data to an external memory.

2. The method of claim 1 further comprising:
storing a second portion of said filtered pixel data in said cache memory.

3. The method of claim 2, wherein said second portion of filtered pixel data comprises a vertical stripe of pixel data one macroblock in height and a horizontal stripe of pixel data at least one macroblock in width.

4. The method of claim 3, wherein said horizontal stripe of pixel data is at least one frame in width.

5. The method of claim 1, wherein said first portion of said filtered pixel data is written to said external memory only one time.

6. The method of claim 1, wherein pixel data stored in said external memory are not required to be read back for edge filtering.

7. A video system comprising:
an image capture device for converting images into a video stream;
an encoder coupled to said image capture device which compresses said video stream;
a filter coupled to said encoder which filters an edge of a group of pixels;
a first memory coupled to said filter, wherein pixel values corresponding to said group of pixels are temporarily cached in said first memory;
a second memory coupled to said filter, wherein filtered pixel values are stored in said second memory.

8. The video system of claim 7 further comprising:
a bus coupled to said filter, said second memory, and a plurality of components, wherein filtered pixel values are transmitted from said filter, over said bus, to be stored in said second memory.

9. The video system of claim 8, wherein select pixel values of said group of pixels are written directly to said first memory from said filter without being transmitted over said bus.

10. The video system of claim 7, wherein said filter and said first memory both reside in a same chip and said second memory is external to said chip.

11. The video system of claim 7, wherein filtered pixel values are written from said filter to said external memory once and only once per filtered pixel value.

12. The video system of claim 11, wherein filtered pixel values are not required to be read out from said second memory for purposes of edge filtering.

13. The video system of claim 7, wherein said first memory stores a stripe of pixel at least one frame across.

14. A method for edge filtering video macroblocks, comprising:
storing a set of pixel values in a first memory, wherein said set of pixel values is used in filtering an edge of a subsequent video macroblock;
reading said set of pixel values from said first memory when said subsequent macroblock is being processed for edge filtering;
filtering pixel values on at least two sides of said edge;
storing filtered pixel values in a second external memory.

15. The method of claim 14 further comprising:
writing said set of pixel values directly into said first memory, wherein said first memory comprises an internal cache memory;
writing said filtered pixel values over an external bus to said second memory, wherein said second memory comprises an external memory chip.

16. The method of claim 14 further comprising:
specifying which portion of a particular macroblock will be needed for filtering any subsequent macroblock and which portion of said particular macroblock will not be needed for filtering any subsequent macroblocks, wherein said portion of said particular macroblock which will be needed for filtering any subsequent macroblock is stored in said first memory and said portion of said particular macroblock which will not be needed for filtering any subsequent macroblock is stored in said second external memory.

17. The method of claim 14 further comprising:
writing a filtered pixel value corresponding to a particular pixel of said macroblock one and only one time into said second external memory.

18. The method of claim 14 further comprising:
reading pixel values corresponding to a previously processed macroblock from said first memory and not from said second external memory for filtering an edge of a current macroblock.

19. The method of claim 14 further comprising:
storing a horizontal stripe of pixel data and a vertical stripe of pixel data in said first memory, wherein said horizontal stripe corresponds to a bottom edge of a macroblock and said vertical stripe corresponds to a right edge of said macroblock.

20. An apparatus comprising:
means for storing a first set of pixel data corresponding to a first block of pixel values in a cache memory;
means for reading said first set of pixel data from said cache memory;
means for filtering said first set of pixel data and a second set of pixel data corresponding to a second block of pixel values to generate filtered pixel data;
means for writing a first portion of said filtered pixel data to an external memory.

21. The apparatus of claim 20 further comprising:
means for storing a second portion of said filtered pixel data in said cache memory.

22. The apparatus of claim 21, wherein said second portion of filtered pixel data comprises a vertical stripe of pixel data one block in height and a horizontal stripe of pixel data at least one block in width.

23. The apparatus of claim 22, wherein said horizontal stripe of pixel data is at least one frame across in width.

24. The apparatus of claim 21, wherein said first portion of said filtered pixel data is written to said external memory only one time.

25. The apparatus of claim 21, wherein pixel data stored in said external memory are not read back for edge filtering.
